(19) United States
(12) Patent Application Publication
(10) Pub. No.: US 2004/0210388 A1
(43) Pub. Date: Oct. 21, 2004

(54) Navigation system

(75) Inventor: Wataru Sugiura, Anjo-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/822,764

(22) Filed: Apr. 13, 2004

(30) Foreign Application Priority Data
Apr. 18, 2003 (JP) 2003-114257

(51) Int. Cl. G01C 21/30

(52) U.S. Cl. 701/209; 701/210

(57) ABSTRACT

A vehicle navigation system includes a program for providing route guidance to a preset location, determining an arrival at the preset location, and scoring points. Points assigned to the preset location are added to a score variable when the arrival at the preset location is determined and the score is stored in a RAM. With this configuration, the vehicle navigation system has game value in addition to a guidance function.

### CROSS REFERENCE TO RELATED APPLICATION

This application is based on and incorporates herein by reference Japanese Patent Application No. 2003-114257 filed on Apr. 18, 2003.

### FIELD OF THE INVENTION

The present invention relates to a navigation system that scores points based on an arrival at a guide point.

### BACKGROUND OF THE INVENTION

A game device having a position detection device is proposed in JP-A-2002-273054. In this device, an arrival at a specified point is determined when user position coordinates (latitude, longitude) provided by the global positioning system (GPS) match coordinates (latitude, longitude) of the position. Then, an image is displayed.

The determination is not much different from that of an arrival at a way point or a destination performed during navigation. Namely, it has neither game value nor a guidance function to a point specified by a user. The known navigation systems have a function for setting a hotel or an amusement park as a destination (way point) and guiding a driver to the destination. However, they lack of entertainment value and game value.

### SUMMARY OF THE INVENTION

The present invention therefore has an objective to provide a navigation system that has game value using functions including a function of determining an arrival at a way point or a destination and a guidance function. A navigation system of the present invention includes a guiding means, and arrival determining means, and a scoring means. The guiding means is provides guidance to reach a preset location. The arrival determining means determines an arrival at a guide point that is provided as the preset location in the route guidance by the guiding means. The scoring means scores points based on the determination performed by the arrival determining means and stores the score.

With this configuration, the navigation system provides guidance to the preset location, scores points when a vehicle or a person travel with this navigation system arrives at the guide point, and stores the score. Namely, the navigation system includes an application with game value of linking an arrival at a location to scoring points, using functions of the navigation system including a function for determining an arrival at a destination and a guidance function. In the navigation system, the scoring means scores points based on an arrival time at the guide point, and stores the score.

In this specification, “Location” refers to a conception of area with a certain extent including an exact spot. “Scoring” refers to a conception of calculation including addition, multiplication, and other operations. “Arrival time at the guide point” refers to a conception of time including time expended to reach the guide point and arrived time at the guide point.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of a vehicle navigation system according to an embodiment of the present invention;

FIG. 2 is a diagram showing an example of a display including way points, passing order of the way points, time limits, and a list of points assigned to each way point;

FIG. 3 is a flowchart of a guidance routine of a rally program;

FIG. 4 is a flowchart of the guidance routine of the rally program;

FIG. 5 is a diagram showing the first pattern of guidance display;

FIG. 6 is a diagram showing a bearing BRG of a way point with respect to a travel direction of a vehicle;

FIG. 7 is a diagram showing a heading HDG of the traveling direction of the vehicle;

FIG. 8 is a diagram showing the second pattern of guidance display;

FIG. 9 is a diagram showing the second pattern of guidance display;

FIG. 10 is a diagram showing an example of a display at an arrival at a way point;

FIG. 11 is a diagram showing an example of the display at an arrival at a destination;

FIG. 12 is a diagram showing a game menu display screen;

FIG. 13 a diagram showing a list of information regarding way points, angles of directions to the way points, and distances to the way points;

FIG. 14 is a diagram showing an example of an at-a-glance map display;

FIG. 15 is a diagram showing an arrangement of points in a point list;

FIG. 16 is a diagram showing an arrangement of the points in the point list shown in FIG. 15 for guiding to the way points in the inverse order; and

FIG. 17 is a diagram showing a game menu display.

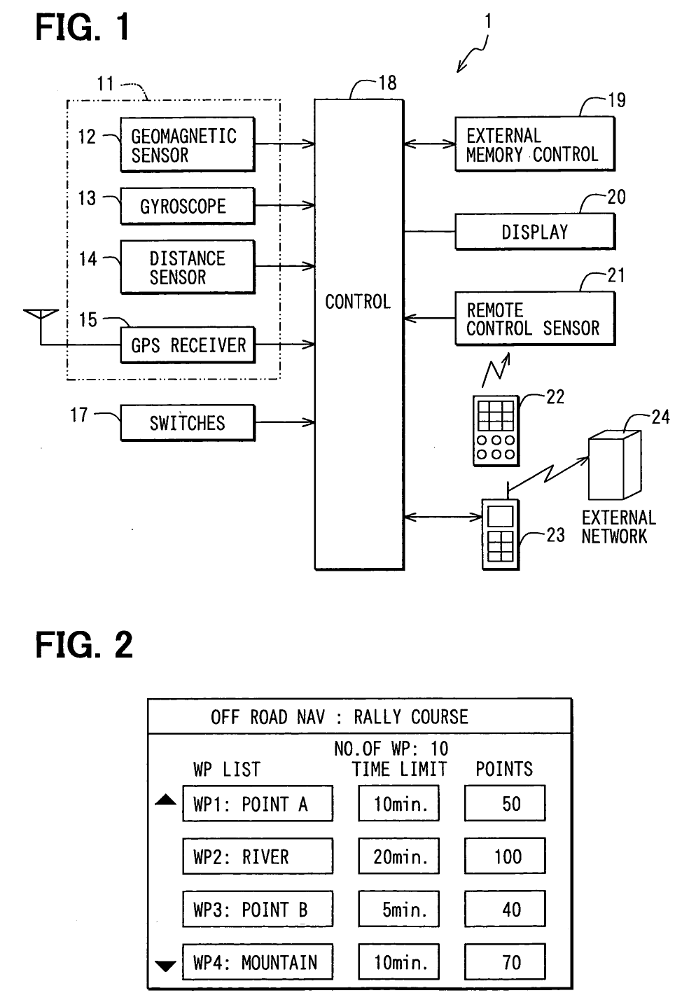

### DETAILED DESCRIPTION OF THE PREFERRED EMBODIMENT

The preferred embodiment of the present invention will be explained with reference to the accompanying drawings. In the drawings, the same numerals are used for the same components and devices. A vehicle navigation system 1 of the present invention includes a position detector 11, a group of operation switches 17, an external memory control device 19, a display device 20, a remote control sensor 21, and a control circuit 18 connected with these devices.

The display device 20 has a display screen, such as a liquid crystal display, and a microphone. It displays the image on the display screen when an image signal is inputted from the control circuit 18, and outputs voice via a speaker when a voice signal is inputted from the control circuit 18.

The operation switches 17 include multiple push buttons (mechanical switches) provided around the display screen of the display device 20 and an input device such as a touch panel overlaid on the display screen. It outputs signals to the control circuit 18 based on inputs from the push buttons or through a touch and a trace on the touch panel by the user. The remote control sensor 21 outputs signals received from the remote control 22 that sends radio signals via infrared rays based on operations by the user to the control circuit 18.

The position detector 11 includes known geomagnetic sensor 12, gyroscope 13, vehicle speed sensor 14, and GPS receiver 15 for the Global Positioning System (GPS). The GPS receiver detects a position of a vehicle based on radio waves sent from a satellite. The position detector 11 outputs current position information based on the detected information by these sensors 12-15 to the control circuit 18. Because these sensors 12-15 have different types of errors, they are configured so that multiple sensors are complementarily used. Only some of sensors may be included depending on an accuracy requirement. Furthermore, a steering rotation sensor and wheel sensors for respective drive wheels, which are not shown, may be included.

The external memory control device 19 controls data reading from DVD-ROM, Hard Disc Drive (HDD) or an external storage medium such as a memory card. If available, the external memory control device 19 controls data writing to the external storage medium. Information stored on the external storage medium includes map-matching data for improving the accuracy of the position detection, various kinds of data including map data and index data, and programs for operating the vehicle navigation system 1.

The control circuit 18 is configured as a regular computer, in which a CPU, a ROM, a RAM, a flash memory, an I/O, and bus lines that connect these components are provided. The control circuit 18 loads programs from the ROM and the external memory control device 19, and executes the programs for operating the vehicle navigation system 1.

During the execution of the programs, it reads information out of the ROM, the RAM, and the flash memory, writes information on the RAM and the flash memory, and passes signals to and from the position detector 11, the group of operation switches 17, the external memory control device 19, the display device 20, and the remote control sensor 21. More specifically, the control circuit 18 loads a boot-up program and an operating system (OS) from the ROM during a startup of the vehicle navigation system 1, and executes them. It performs hardware-control and process management based on the OS. Programs run on the OS include a menu program, a route search program, and a map display program, and other programs.

The menu program hierarchically displays various programs that run on the OS in the form of a menu on a functional or a subjective basis. It starts one of the displayed programs on the menu selected by the user. The menu is displayed by outputting image data of the menu to the display screen of the display device 20. The user selects one of the programs via a remote control terminal (RC) 22 or the operation switches 17. The menu program detects the program selected by the user based on a signal inputted to the control circuit 18 through the selecting operation by the user using the RC 22 or the operation switches 17. The signal is inputted from the RC 22 via a remote control sensor 21 or from the operation switches 17 by moving cursor or pressing a confirmation button.

The route search program automatically searches an optimal route from the current position to a destination when a location of the destination is inputted via the RC 22 or the operation switches 17. Then, it displays the optimal route as a guide route on the display device 20. Dijkstra's algorithm may be used for an automatic search for an optimal route.

The map display program displays a current position mark, map data, and supplemental data on the display device 20 in a manner that they are superimposed. The current position mark that indicates the current position of the vehicle is displayed based on the current position information inputted from the position detector 11. The map data is read out by the external memory control device 19, and the supplemental data including the guide route is produced by the route search program. Furthermore, the onboard navigation system is connectable with the external network 24 via a mobile communication device such as a cellular phone 23, and a dedicated information center through the Internet.

One of the programs started by the menu program through the selecting operation is a rally game program. The rally game program provides audio and visual guidance in off-road areas including deserts and off-road fields. The user sets a destination, way points including a destination, passing order of way points, and a time limit in the off-road area. Then, the rally game program performs the audio and visual guidance to the way points by providing a direction, such as a bearing, and a distance to the way points.

If the vehicle has reached (passed or arrived) the way point within the time limit, it adds predetermined points assigned to the way point and stores the score in the RAM. If vehicle has not reached within the time limit, it adds half of the predetermined points assigned to the way point and stores the score in the RAM. Namely, it scores points based on time expended to reach the guide point, and records the points. Then, it displays a total point when the vehicle has reached the destination.

Steps of this rally game program will be explained in detail. The destination, the way points, the passing order of the way points, and the time limit are already determined by another routine. An example of a display including the way points, the passing order of the way points, time limits, and a list of points assigned to each way point are shown in FIG. 2. Each line of the way point list includes the name of way point, the time limit to reach the way point, and the points assigned to the way point in this order from the left. Regarding the passing order of the way points, the way points are displayed in ascending order from the top to the bottom. The way points, the passing order of way points, the time limit, and the way point list are stored in the RAM of the control circuit 18.

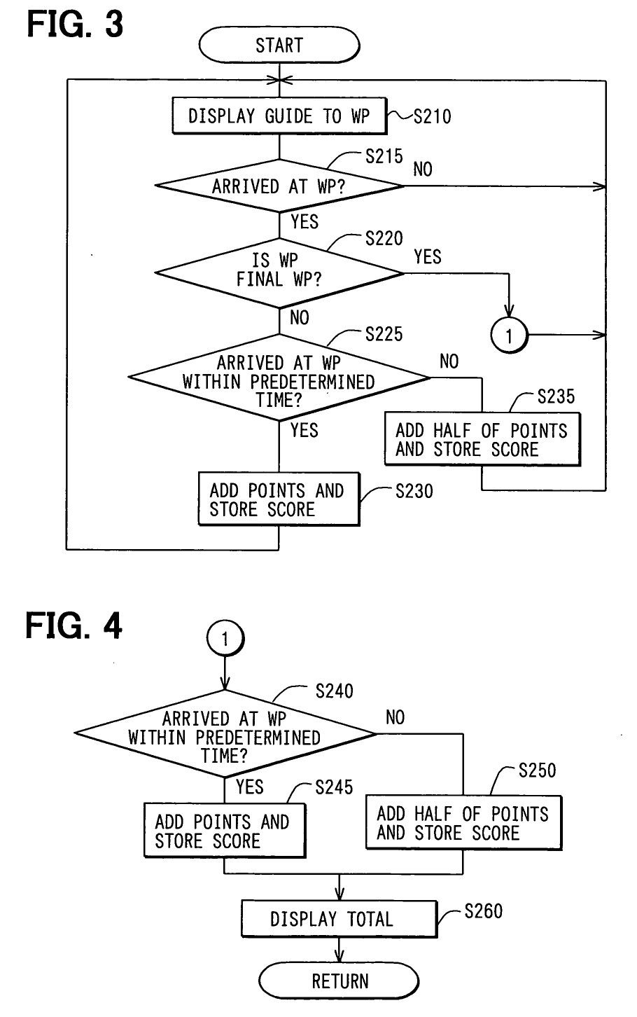

When the rally game program is started, the program sets a score variable in the RAM and initializes the score variable by setting it to zero. The program also sets a next way point variable in the RAM and sets the way point variable to the furthest way point. Then, it executes a guidance routine shown in flowcharts of FIGS. 3 and 4. In this guidance routine, route guidance to the way point, which is a preset location, is displayed (S210). There are three patterns of the guidance display.

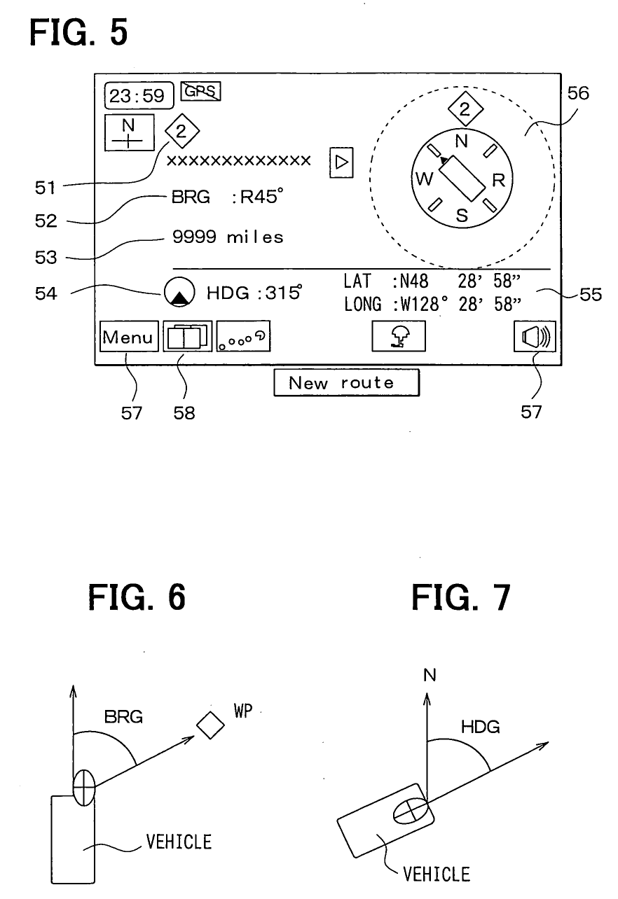

The first pattern of guidance display is shown in FIG. 5. Mark and name of a way point for which the vehicle is currently heading are displayed in a way point name display section 51. The way point for which the vehicle is currently heading can be determined by referring to the way point variable. A bearing BRG of the way point with respect to the traveling direction of the vehicle is displayed in a way point bearing display section 52 as shown in FIG. 6. R45° indicates 45° to the right. If 80° to the left, it will be indicated with L80°. The bearing BRG is calculated from the current position of the vehicle detected by the position detector 11, the traveling direction of the vehicle, and the location of the set way point.

A distance between the position of the vehicle and the location of the way point is displayed in the way point distance display section 53. A heading HDG of the traveling direction of the vehicle is displayed in a vehicle heading display section 54. The heading HDG is defined with reference to the north as shown in FIG. 7 and displayed in a value between 0° and 360° (absolute heading) in steps of 5°. The latitude and longitude of the current position of the vehicle is displayed in a vehicle position display section 55. The relationship between the traveling direction of the vehicle and the direction to the way point is visually indicated in a compass display section 56.

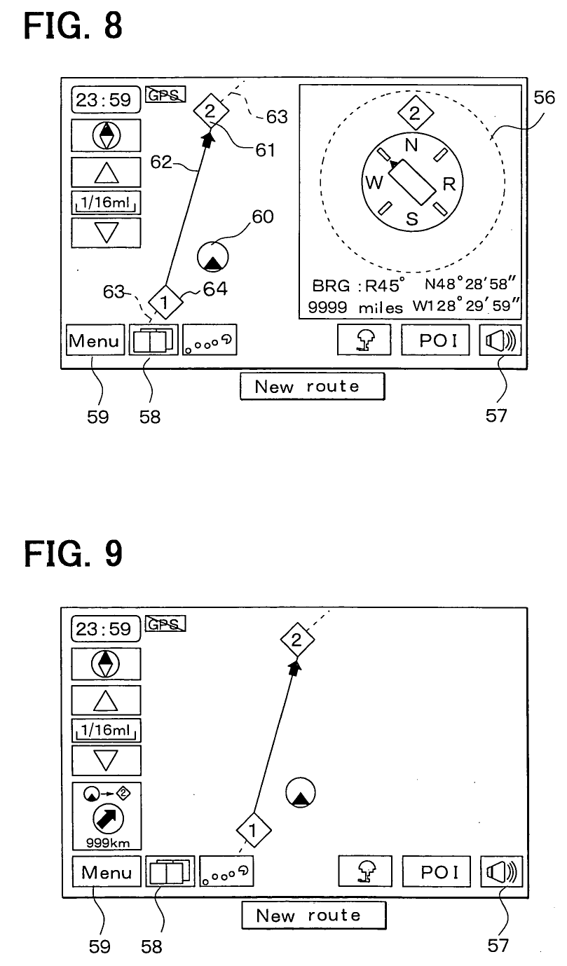

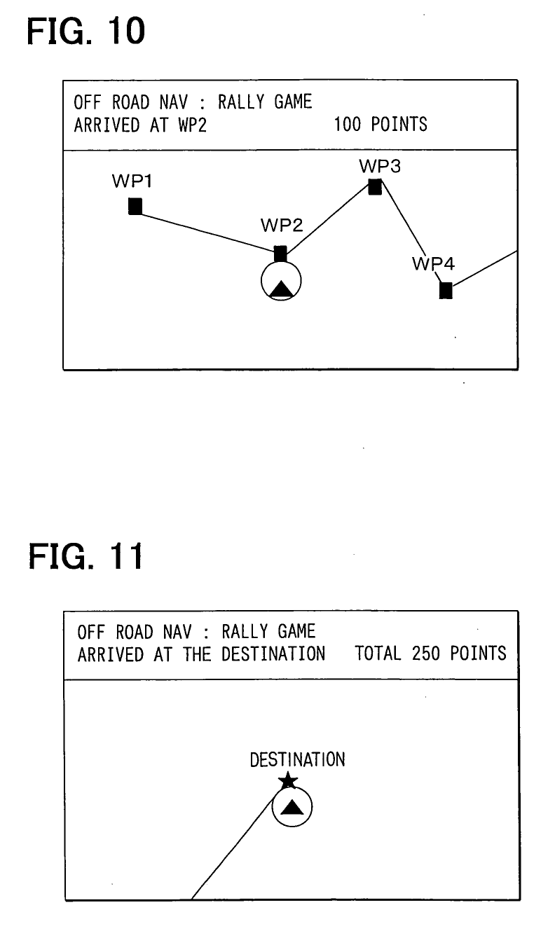

The second pattern of guidance display is shown in FIG. 8. The guidance routine displays a map in the areas of the name display section 51, the bearing display section 52, the distance display section 53, and the heading display section 54 of the display pattern shown in FIG. 5. The map including the current position 60 and the way point 61 for which the vehicle is currently heading is read out of the external memory control device 19.

The guidance routine also displays straight lines that connect the way points in the passing order on a continual basis. A line 62 that connects the previous way point 64 and the current way point 61 is indicated differently from other lines 63. The current way point 61 is the guide point for which the vehicle is currently heading and the previous way point 64 is the guide point for which the vehicle previously headed. More specifically, the line 62 is indicated with a solid line, and the other line 63 is indicated with a dotted line. The lines may be indicated in different colors instead of the solid and dotted lines. By indicating the line 62 differently from other line 63, the user can clearly recognize the point for which the vehicle is currently heading.

The third pattern of guidance display is shown in FIG. 9. The compass display section 56 of FIG. 8 is not included in the display so that the wider area of the map can be displayed. A display mode selector switch 58 shown in FIGS. 5, 8, 9 is displayed on the display screen of the display device 20. When this selector switch 58 is selected through an operation of the operation switches 17 or the RC 22, the rally game program switches the display in rotation of FIGS. 5, 8, 9 in this order based on the selection.

In the displays shown in FIGS. 5, 8, 9, an audio signal may be outputted to the display device 20 for providing audio guidance regarding the bearing BRG and the distance to the next way point. When an audio repeat switch 57 shown in FIGS. 5, 8, 9 is selected by the user, the guidance routine detects the selection and issues an instruction to the display device 20 for providing audio guidance again.

After the guidance to reach the way point is displayed in step S210, it is determined whether the vehicle has arrived at the way point for which it is currently heading (S215). Namely, an arrival at a guide point that is provided as the way point in the route guidance display step (S210) is determined. The arrival is determined when the distance between the set way point location and the current position of the vehicle is within a predetermined distance. The predetermined distance is set in the rally program, for instance, at 50 m. If it is determined the vehicle has not arrived at the way point, the process returns to step S210.

If an arrival of the vehicle at the way point is determined, it is determined whether the way point is the destination, namely, the final way point (S220). It is determined whether the way point is the final way point based on whether it is listed at the end of the way point list. If it is the final way point, it is determined whether the vehicle has arrived at the final way point within the time limit.

If it is not the final way point, namely, if it is a regular way point, it is determined whether the vehicle has arrived at the way point within the time limit (S225). More specifically, the arrival at the way point within the time limit is determined when the difference between the current time and the previous way point arrival time is equal to or smaller than the time limit set for the currently arrived way point. If not, it is determined that the vehicle has not arrived at the way point within the time limit.

If the arrived way point is the first way point, it is determined whether the difference between the current time and the start time of the guidance routine is equal to or smaller than the required time. If the user decides not to go to the way point and to take the next way point as a new target point, the current way point can be skipped. In such a case, namely, if the previous way point has been skipped, it is determined whether the difference between the current time and the time at which the skip has been performed is equal to or smaller than the time limit.

If it is determined that the vehicle has arrived within the time limit, points assigned to the arrived way point are added to the score variable and the score of the score variable is stored in the RAM (S230). Then, the next way point variable is set to the way point next to the currently arrived way point by referring to the way point list stored in the RAM. Audio and visual information regarding the arrival at the way point and the currently added points is outputted to the display device 20. In a map display section of the display screen of the display device 20, “Arrived at way point 2. 100 points,” for instance, is displayed and an audio output indicating the same is provided. Then, the process returns to step S210.

If it is determined that the vehicle has not arrived within the time limit, half of points assigned to the arrived way point are added to the score variable and the score of the score variable is stored in the RAM (S235). Then, the next way point variable is set to the way point next to the currently arrived way point by referring to the way point list stored in the RAM. Audio and visual information regarding the arrival at the way point and the currently added points are outputted to the display device 20. In a map display section of the display screen, “Arrived at way point 2. 100 points,” for instance, is displayed and an audio output indicating the same is provided. Then, the process returns to step S210.

Referring to FIG. 4, it is determined whether the vehicle has arrived at the way point (destination) within the time limit (S240). If the vehicle has arrived at the destination within the time limit, the points assigned to the destination are added to the score variable and the score of the score variable is stored in the RAM (S245). If the vehicle has not arrived at the destination within the time limit, half of the points are added to the score variable and the score of the score variable is stored in the RAM (S250). Then, audio and visual signals that indicate the total point, namely, the current value of the point variable are outputted to the display device 20 (S260). In the map display section of the display screen, “Arrived at the destination. Total 250 points,” for instance, is displayed as shown in FIG. 11 and an audio output indicating the same is provided.

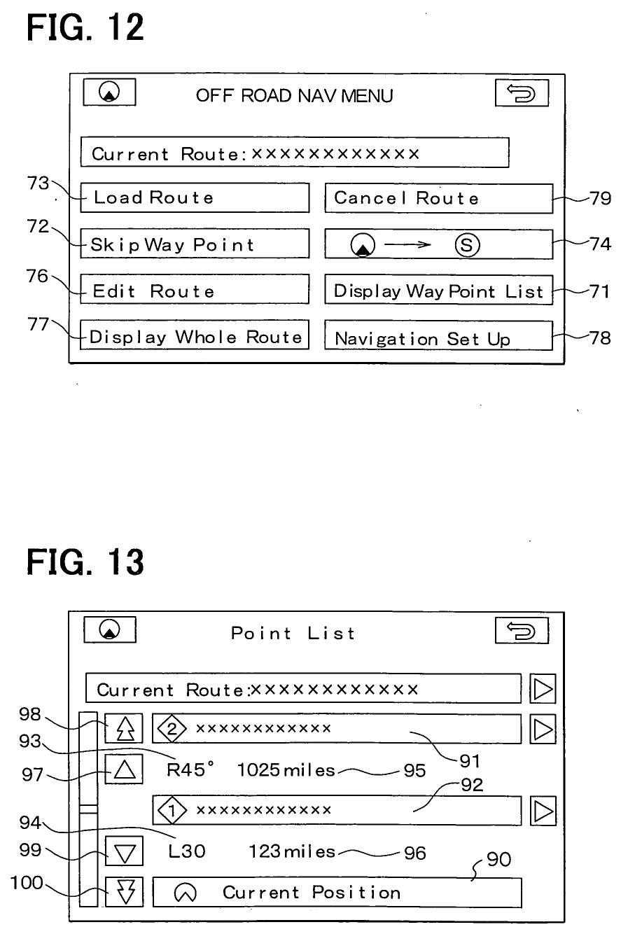

A menu switch shown in FIGS. 5, 8, 9 is displayed on the display screen of the display device 20. When the menu switch 59 is selected through the operation switches 17 or the RC 22, the rally game program halts the guidance routine based on this selection. Then, it outputs image data of the game menu display to the display device 20. The game menu display is shown in FIG. 12. The game menu display includes buttons 71-74, 76-79. An execution of routine corresponding to these buttons 71-74, 76-79 is started by selecting these buttons through the operation switches 17 or the RC 22.

A routine that is started when the [Edit Route] button 76 is selected sets a way point based on an input from the user. The user inputs information including names and locations (latitudes and longitudes) of the way points, time limits, points to assign the way points, order of the way points to be guided. When the information is inputted, the routine writes the inputted information into the RAM of the control circuit 18. A routine that is started when the [Cancel Route] button 79 is selected deletes the way point list stored in the RAM, and terminates the guidance routine that has been running immediately before the menu is displayed.

A routine for displaying a list of information is started when the [Display Way Point List] button 71 is selected. The information includes way points 91 and 92, bearings 93 and 94 of the way points, and distances 95 and 96 between the current position 90 and the way points 91, 92. This list display can be scrolled up with an up scroll button 97 or 98 is selected, and scrolled down when a down scroll button 99 or 100 is selected.

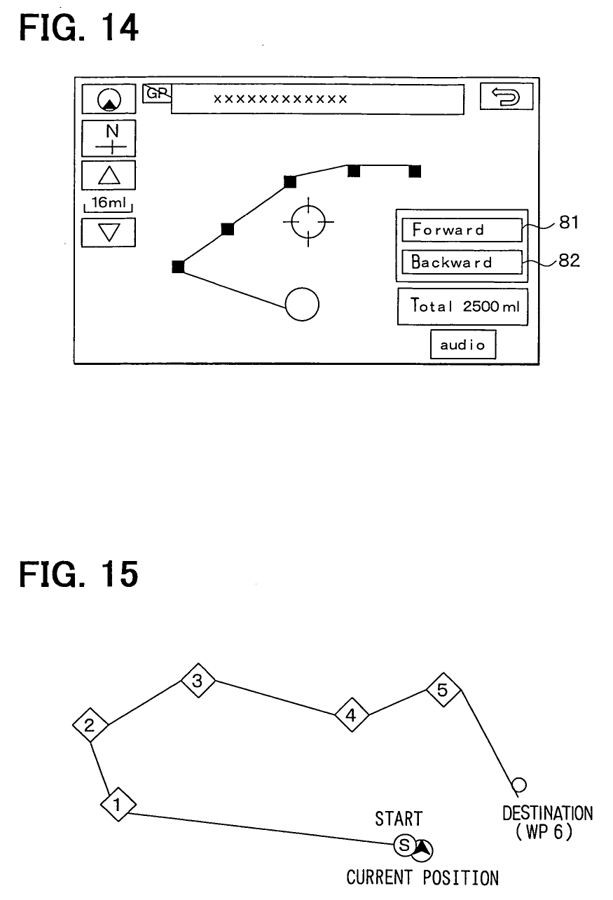

A routine that is started when a [Load Route] button 73 is selected loads a route that is set and registered by the user, and stores the route as a way point list. It also provides an at-a-glance map display that shows all the way points in the way point list, a destination, and straight lines that connect way points in a continual basis in the passing order on the map. The at-a-glance map display is shown in FIG. 14. On the at-a-glance display screen, a [Forward] button 81 and a [Backward] button 82 are displayed.

When the [backward] button 82 is selected through the operation switches 17 or the RC 22, the off road game program generates an inverse order way point list. It sets the first way point listed in the inverse order list in the next way point variable. Then, it starts the guidance routine using the inverse order list instead of the way point list.

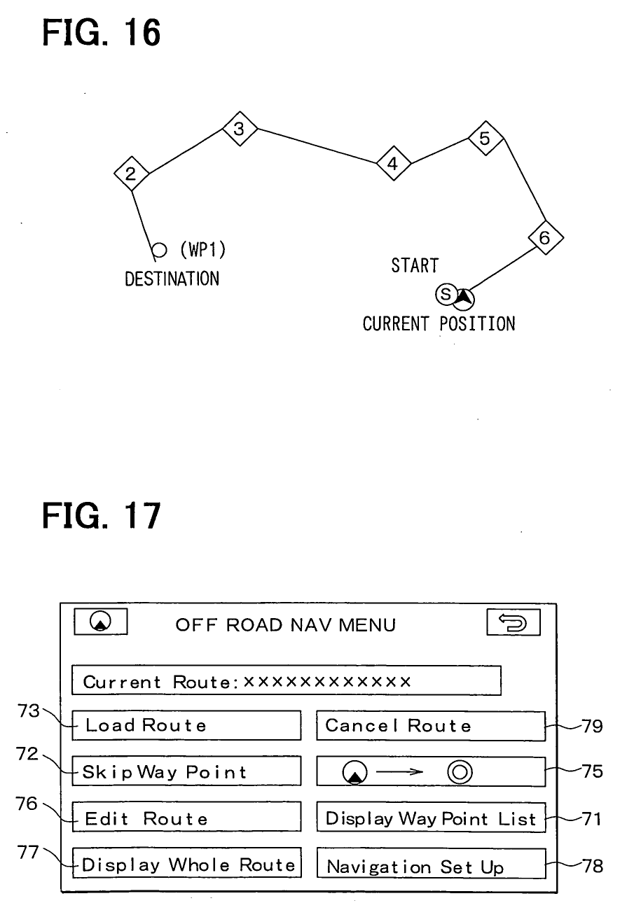

The inverse order list is a list in which the way points listed in the way point list are arranged in the inverse order. If points 1, 2, 3, 4, 5, and 6 are listed in the way point list in this order as shown in FIG. 15, the guidance routine sets point 6 as the first way point. It provides route guidance to the point 6 at first and to go to points 5, 4, 3, 2, and 1 in this order as shown in FIG. 16. In this case, point 1 is referred to as a destination. With this configuration, the user can enjoy an inverse order off road game.

When the [Forward] button 81 is selected, route guidance to the way points in the order listed in the way point list is provided. If a start point route setting switch 74 is selected, the guidance is switched to provide a route for returning to the start point. More specifically, the inverse order list is generated, and the way point next to the currently set next way point in this inverse order list is set as a new next way point in a next way point variable. Then, the guidance routine is restarted with the inverse order list instead of the way point list.

A routine started when the [Skip Way Point] button 72 is selected restarts the guidance routine after setting the way point next to the currently heading way point in the next way point variable. The routine sets the next way point referring to the way point list stored in the RAM. This routine is provided for skipping the currently heading way point when the user decides not to go to the way point and sets the next way point as a new target point. When a [Display Whole Route] button 77 is selected, a program for displaying a whole route shown in FIG. 14 starts. When a [Navigation Set Up] button 78 is selected, an item switching display for switching volume of voice guidance, language of the guidance, and colors of the map.

To display the game menu display screen while the guidance using the inverse order list, the display screen looks as shown in FIG. 17. In this display screen, the start point route setting switch 74 is replaced by the destination route switch 75. When the destination route switch 75 is selected, the way point next to the currently set next way point is set as a new next way point in a next way point variable. Then, the guidance routine is restarted with the way point list instead of the inverse order list that is currently used. As a result, the guidance performed in the inverse order is switched back to the regular order.

With the above configuration, the vehicle navigation system 1 provides guidance to go to a preset location (way point) through the rally game program. When a vehicle or a person that travels with the navigation system 1 arrives at the guide point, points are added. Namely, the arrival at a way point is linked with scoring by using a function for determining an arrival at a way point or a destination and a guiding function. Therefore, an application having game value is provided.

The present invention should not be limited to the embodiment previously discussed and shown in the figures, but may be implemented in various ways without departing from the spirit of the invention. For example, the distance from the way point predetermined for determining an arrival of the vehicle at a way point may be set by the user. The distance may be uniformly set for all way points or differently set for each way point. When the distance is set short, for instance 10 m, a high score may be assigned to the way point because it will be difficult to pass the way point. When the distance is set long, for instance 100 m, a low score may be assigned to the way point.

What is claimed is:

1. A navigation system comprising:
a guiding means for providing route guidance to a preset location;
an arrival determining means for determining an arrival at a guide point that is provided as the preset location in the route guidance by the guiding means; and
a scoring means for scoring points based on the determination performed by the arrival determining means and storing the score.

2. The navigation system according to claim 1, wherein the guiding means provides the guidance by showing a direction to the preset location.

3. The navigation system according to claim 2, wherein the guiding means provides the guidance by further showing a distance to the preset location.

4. The navigation system according to claim 1, wherein the arrival determining means determines the arrival at the preset location when a distance between the preset location and a current position is within a predetermined distance.

5. The navigation system according to claim 1, wherein the scoring means scores points based on an arrival time at the guide point, and stores the score.

6. The navigation system according to claim 5, wherein the scoring means scores points based on an arrival time at the guide point and a preset time limit, and stores the score.

7. The navigation system according to claim 5, wherein the scoring means scores points based on time between an arrival at a previous guide point determined by the arrival determining means and an arrival at a current guide point that the guiding means provides as a preset location in the route guidance.

8. The navigation system according to claim 1, wherein the guiding means displays at least one of preset locations and a line that connects the preset locations on a continual basis.

9. The navigation system according to claim 1, wherein:
the guiding means displays the preset locations and lines that connect the preset locations on a continual basis; and
the guiding means indicates the line that connects the previous guide point and the current guide point differently from the other lines.
